(19) United States
(12) Patent Application Publication
(10) Pub. No.: US 2002/0082946 A1
(43) Pub. Date: Jun. 27, 2002

(54) Electronic auction method and system permitting simultaneous bids on multiple, different items

(76) Inventors: William James Morrison, Gilmanton, NH (US); Kim Delaney Murphy, Austin, TX (US); Rebecca Lynn Roberts, Austin, TX (US); Leland James Wiesehuegel, Austin, TX (US)

Correspondence Address: Duke W. Yee, Carstens, Yee & Cahoon, L.L.P, P.O. Box 802334, Dallas, TX, 75380, US

(21) Appl. No.: 09/746,176

(22) Filed: Dec. 21, 2000

(51) Int. Cl. G06F 17/60

(52) U.S. Cl. 705/27

(57) ABSTRACT

An electronic auction method and system are disclosed for permitting simultaneous submission of bids on multiple different items from a single screen image. Multiple different items which are offered for auction are simultaneously displayed on the single screen image. Each of these items may be offered for auction simultaneously using different auction types. Entry of bids is permitted for some or all of these items using the single screen image. The entered bids are then simultaneously submitted from the single screen image. A single confirmation screen image is then displayed which includes simultaneous confirmation of each submitted bid. A single result screen image is also displayed to indicate the results of the submitted bids.

### BACKGROUND OF THE INVENTION

1. Field of the Invention

The present invention relates generally to data processing systems and more particularly to electronic commerce. Still more particularly, the present invention relates to an electronic auction method and system which permits simultaneous bids on multiple, different items from a single, displayed screen image.

2. Description of the Related Art

Prior to the advent of electronic auctioning over computer networks or electronic commerce, auctions were held in a group of gathered bidders with an auctioneer. In traditional auctions, an auction is conducted on behalf of a seller by an auctioneer. The auctioneer receives a list of items to be sold and possibly a minimum and/or reserve price for those items. During the auction, a plurality of bidders place bids under the guidance and control of the auctioneer. In some cases, multiple bidders may pool their bids, and the pooled bids are submitted as a single bid with a combined quantity to the auctioneer.

The auctioneer enforces the rules of the auction, such as minimum bid price and quantities, minimum bid incrementing from the previous bid for a new bid, and time limits for placing bids. Auction bidders are typically qualified as to their ability to complete the purchase should their bid be the winning bid prior to entering the auction room.

Many online auctioning systems such as “priceline.com” and “mercata.com” have become very popular for individuals and businesses to use to take advantage of auctions at which they cannot be physically present. Such e-commerce auctions or online auctions are usually conducted over a specified period of time of opening and closing for bids, and are typically conducted under one of several well-known sets of rules or models. These common models include “Dutch” auctions, progressive auctions, “Yankee” auctions, single-bid auction, reserve auctions, and hybrids of these types of auctions. The “Dutch” and “Yankee” auctions permit bids on a part of or the whole offered lot.

However, most sales offering and bid systems conducted by manufacturers of goods or service providers are conducted under a different set of procedures and processes. In a typical trader and broker system for offering and accepting bids, a manufacturer or service provider will notify one or more traders of available products or services, quantities, and minimum acceptable bid values. The trader then provides offerings to one or more brokers, to which the brokers may respond with bids.

In some cases, bids may be accepted for either partial lots or whole lots of offered products. These offerings and the corresponding bids are collected by the trader, and the trader makes a decision about which bids to accept. The traders subsequently respond to the manufacturer or service provider with actual orders or purchases.

Although the B2B offering and bid acceptance process may be conducted similarly to an auction, it is not an auction in the strict sense in that the order fulfillment, or bid acceptance, process is conducted usually by the trader at his discretion. For example, under a typical auction process, the highest qualified bidder may be defined as the bid winner. However, in a B2B offering and bid collection system, the trader may favor the second or third highest bid over the highest bid because the broker placing the second or third highest bid has preferred business arrangements, such as a longer history of purchasing from the trader or a history of larger volume purchases with the trader.

In typical electronic auctions, potential buyers may view items available for sale through the auction. The buyer must first select an item. Once the item is selected, a new screen image, or web page, is displayed which gives current information regarding the auction of that item, such as the number of items available and currently required minimum bid. If the buyer wishes to place a bid, a different screen image, or web page, is displayed which includes an entry field into which the buyer may enter a bid. Once the buyer has entered a bid, the buyer may submit the bid. Another screen image is then displayed which permits the buyer to review and confirm the bid. Thereafter, a result screen image is displayed which shows the buyer the results of the bid. The buyer, thus, goes through three separate screen images in order to place a bid, confirm a bid, and see the results of the bid.

If the buyer had originally wished to bid on two or more different items, the buyer must repeat the process described above separately for each different item. Therefore, for example, if the buyer wanted to bid on five different items, this process must be repeated five different times. In order to place five different bids, the buyer must go through fifteen different screen images.

Therefore, a need exists for a method and system in an electronic auction which permits simultaneous bids on multiple different items from a single, displayed screen image.

### SUMMARY OF THE INVENTION

An electronic auction method and system are disclosed for permitting simultaneous submission of bids on multiple different items from a single screen image. Multiple different items which are offered for auction are simultaneously displayed on the single screen image.

Each of these items may be offered for auction simultaneously using different auction types. Entry of bids is permitted for some or all of these items using the single screen image. The entered bids are then simultaneously submitted from the single screen image. A single confirmation screen image is then displayed which includes simultaneous confirmation of each submitted bid. A single result screen image is also displayed to indicate the results of the submitted bids.

The above as well as additional objectives, features, and advantages of the present invention will become apparent in the following detailed written description.

### BRIEF DESCRIPTION OF THE DRAWINGS

The following detailed description when taken in conjunction with the figures presented herein provide a complete disclosure of the invention.

FIG. 1 depicts the structure of offerings according to the present invention;

FIG. 2 illustrates a broker profile matrix according to the present invention;

FIG. 3 depicts a general architecture of an Interactive Offer Server (“IOS”) in which the present invention may be implemented;

FIG. 4 is an exemplary block diagram of a server according to the present invention;

FIG. 5 is an exemplary block diagram of a client according to the present invention;

FIG. 6 illustrates a single screen image which depicts simultaneously displaying all offerings currently for sale according to the present invention;

FIG. 7 depicts a single screen image which illustrates simultaneously displaying all part lots of one offering when only one offering is selected according to the present invention;

FIGS. 8A and 8B together illustrate a single screen image which depicts simultaneously displaying all part lots of all offerings when all offerings are selected according to the present invention;

FIG. 9 illustrates a single screen image which depicts simultaneously confirming all offers prior to the offers being recorded according to the present invention;

FIG. 10 depicts a single screen image which illustrates a single screen image which indicates the results of the offer submission according to the present invention; and

FIG. 11 illustrates a high level flow chart which depicts simultaneously submitting offers on multiple different items in an electronic auction according to the present invention.

### DETAILED DESCRIPTION OF THE INVENTION

The present method and system is preferably realized in a plurality of networked computers, including computer network terminals or consoles, networked database application servers, web servers, and a computer network. The computer network consoles employed are any suitable device for accessing remote application services over a computer network, including, but not limited to: personal computer-based web browsers, wireless web browsers such as web-enabled wireless telephones and personal digital assistants (“PDA”), Internet appliances, and dedicated computer terminals. The database application servers employable in the invention may be any of a wide array of available database application servers, including, but not limited to: IBM Lotus Notes servers, Oracle servers, etc. The web servers incorporated into the invention may be any suitable platform, including, but not limited to: IBM's WebSphere product, Apache Hyper Text Transfer Protocol (“HTTP”) servers, secure HTTP servers (“HTTPS”), and the like. The computer network may include the Internet, intranets, extranets, dedicated networks such as local area networks (“LAN”) and wide area networks (“WAN”), wireless data networks, and/or any other suitable computer and data communications network. Communications means between database application servers, computer network consoles, and web servers may include any suitable data communications protocols and media including, but not limited to: dial-up modems over telephone lines, wireless data transceivers, cable modems, Digital Subscriber Lines (“DSL”), and dedicated data communication lines.

It will be recognized by those skilled in the art that certain combinations and integrations of the features presented herein may be made without departing from the spirit and scope of the invention. Further, it will be recognized that many of the architectural details disclosed herein are disclosed under the inventor's preferred embodiment in order to enhance the robustness and reliability of the invention, but these details may not be necessary to realize the fundamental functionality of the invention.

The present invention is an electronic auction method and system which permits a potential buyer to submit bids on multiple different items simultaneously. A single screen image is displayed which permits entry of multiple different bids on multiple different items. In addition, each of these items may be offered for auction using one of several different auction methods. All available items being auctioned are simultaneously displayed to a potential buyer using a single screen image regardless of the type of auction used for each item. The buyer is then permitted to enter a bid on one or more of the available items from the single screen image. The entered bids are then simultaneously submitted from that single screen image.

A single confirmation screen image is then provided to the buyer after the bids have been entered. The single confirmation screen image simultaneously confirms all bids. If the buyer chooses to complete the submission process, a single result screen image is used to confirm the recordation of all of the submitted bids.

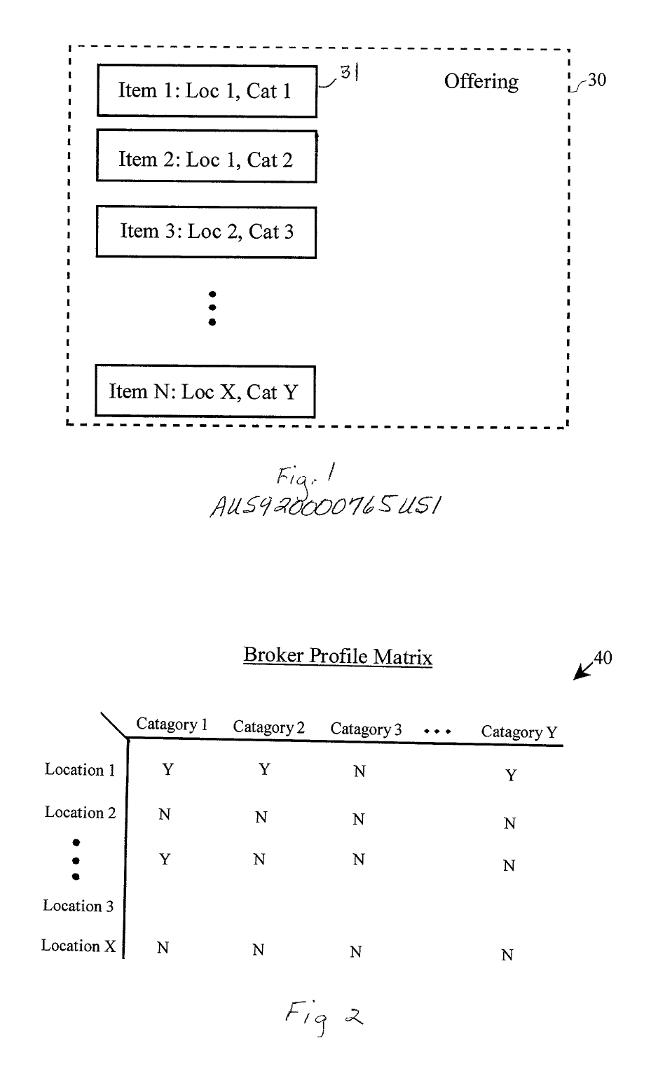

Turning to FIG. 1, broker offerings 30 are comprised of one or more sets of materials (or services) associated with location and category code pairs. Typically, locations are related to geographical zones or regions such as countries, continents, or sales regions. Categories are typically related to products, product lines, or services such as computers, hard drives, monitors, minutes of long-distance, megabytes of transmission or other types of services and products. As such, an offering 30 which is presented to a broker contains only materials or services which are being made available to that broker for which the location and category code meet his broker profile. And, the offering may include materials from a combination of brokers. For example as shown in FIG. 1, an offering 31 to a European broker may be comprised of a first material code pair such as location=Europe, and category=power supply. It may also include additional materials with associated location and category pairs, such as location=Europe and category-computer₁₃monitor, and location=Germany and category=Deutsche₁₃AIX₁₃operating system.

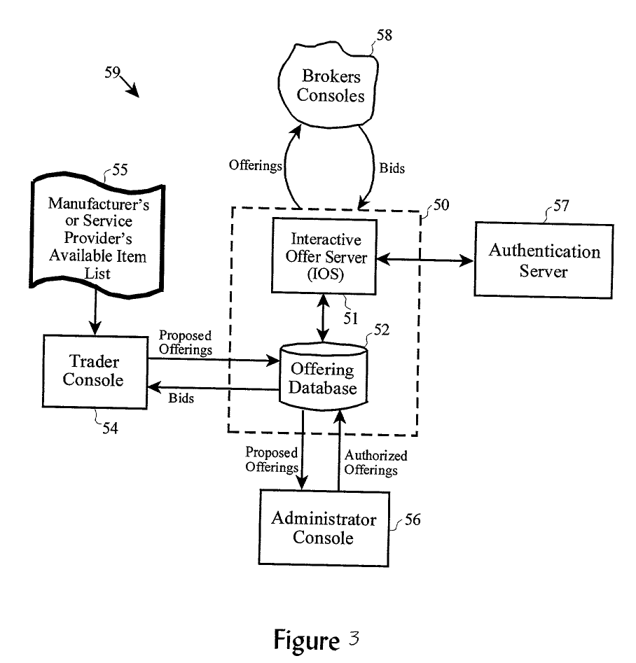

A broker profile matrix is disclosed in FIG. 2. For each broker, a broker profile matrix is defined which is a two-dimensional table for location and category in this preferred embodiment. In this example of FIG. 2, the locations are indexed against the plurality of categories, and then a logical enabler, such as a Boolean flag, is recorded for each combination of location and category pairs. A profile matrix defines the “entitlement” for a particular broker. Available products or services which match the location-category parameter pairs a broker's entitlement profile matrix are made available to that broker, and products and services which do not meet the parameters of the profile matrix are not presented for bidding to that broker. For example in FIG. 2, the completed profile matrix for a hypothetical broker defines that the broker is entitled to receive in offerings for category₁₃1 products in location₁₃1 and location₁₃3, and for category₁₃2 products only in location₁₃1, and for category₁₃Y products only in location₁₃1. The hypothetical broker of this example is not authorized or entitled to receive offerings for any other location-category parameter pair.

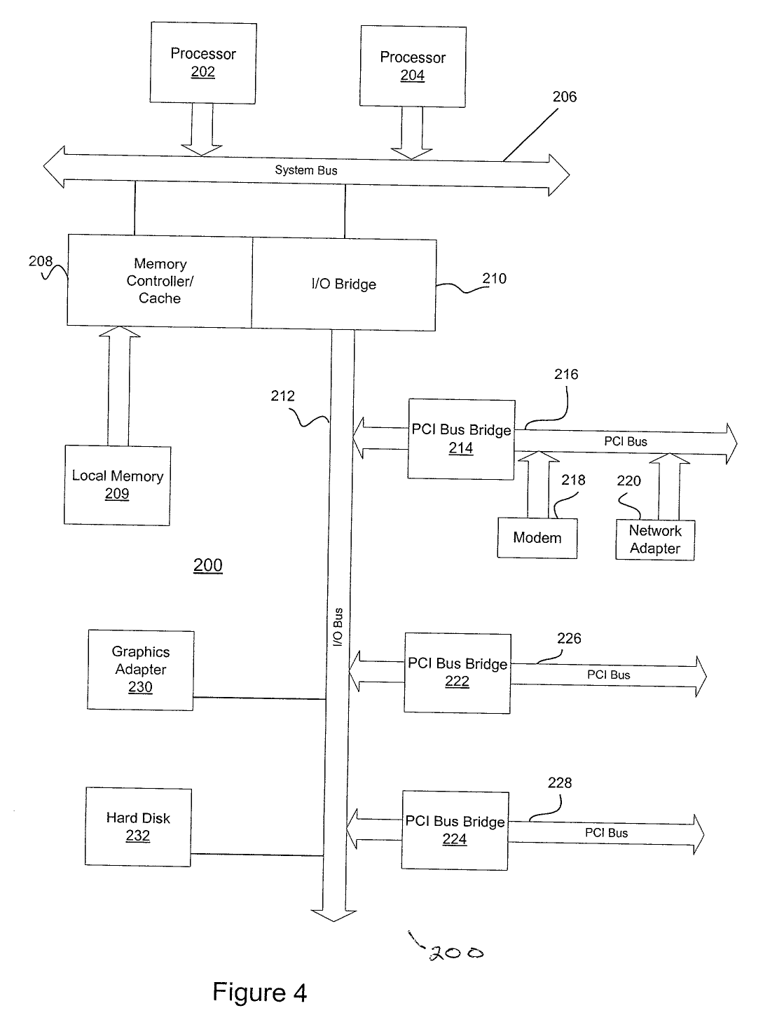

Turning to FIG. 3, in which the general architecture of the system of the invention is shown, the Interactive Offer System (“IOS”) 51 is associated with an offering database 52. The offering system 50 is included in the larger architecture 59 which includes the brokers' consoles 58, the administrator console 56, and the traders' consoles 54. All consoles and the interactive offering server may communicate either as an integrated package within one computer system, or as separate computer systems integrated and communicating over a computer network such as the internet.

In the general architecture of FIG. 3, the manufacturer or service provider's goods availability list 55 is received by the trader consoles 54. The trader then creates proposed offerings by filtering the availability list against the broker profile matrices 40 for his broker(s). Those proposed offerings are input into the offering data base 52, which are then retrieved by the administrator using his administrator console 56.

The administrator then authorizes the proposed offerings and makes a note or change in the offering data base records to indicate such authorization.

During the open bidding process, the brokers may use their consoles, such as web browser personal computers 58, to retrieve their offerings, and to submit bids via the IOS 51. When a broker makes contact with the interactive offering server, his identity is first verified by an Authentication Server 57, according to the preferred embodiment.

In response to the broker's request for products or services offerings, the IOS queries the offering database 52 and presents the broker with offerings to which he or she is entitled. An authentication server 57 is included in the preferred embodiment so as to allow the interactive offering server to authenticate the broker prior to presenting any offerings to the broker. As such, the general architecture 59 as shown in FIG. 3 provides each broker with one or more offerings which have been authorized and which have been filtered only to show available materials or services on which he is entitled to bid.

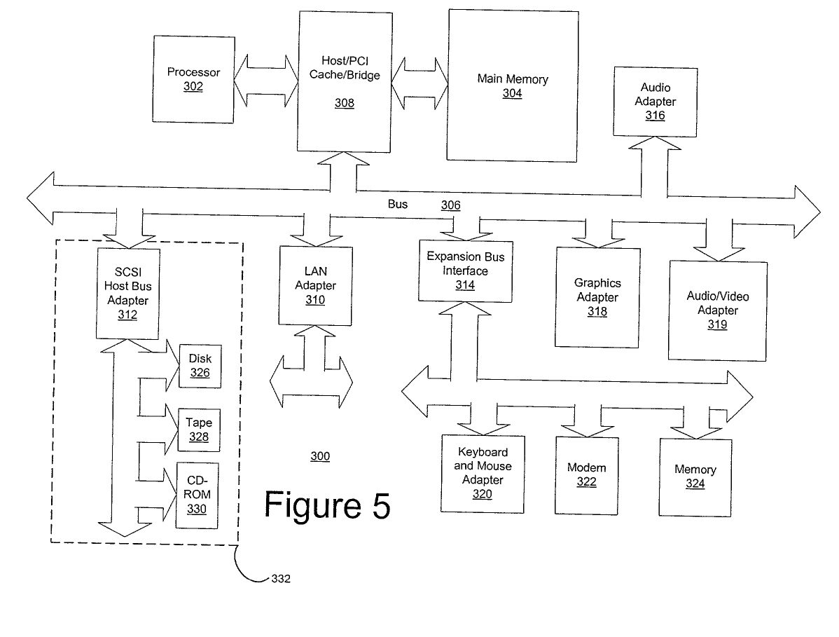

FIG. 4 illustrates a block diagram of a data processing system which may be implemented as IOS server 51 in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to other network computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 4 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 4 may be, for example, an IBM RISC/System 6000 system, a product of International Business Machines Corporation in Armonk, N.Y., running the Advanced Interactive Executive (AIX) operating system.

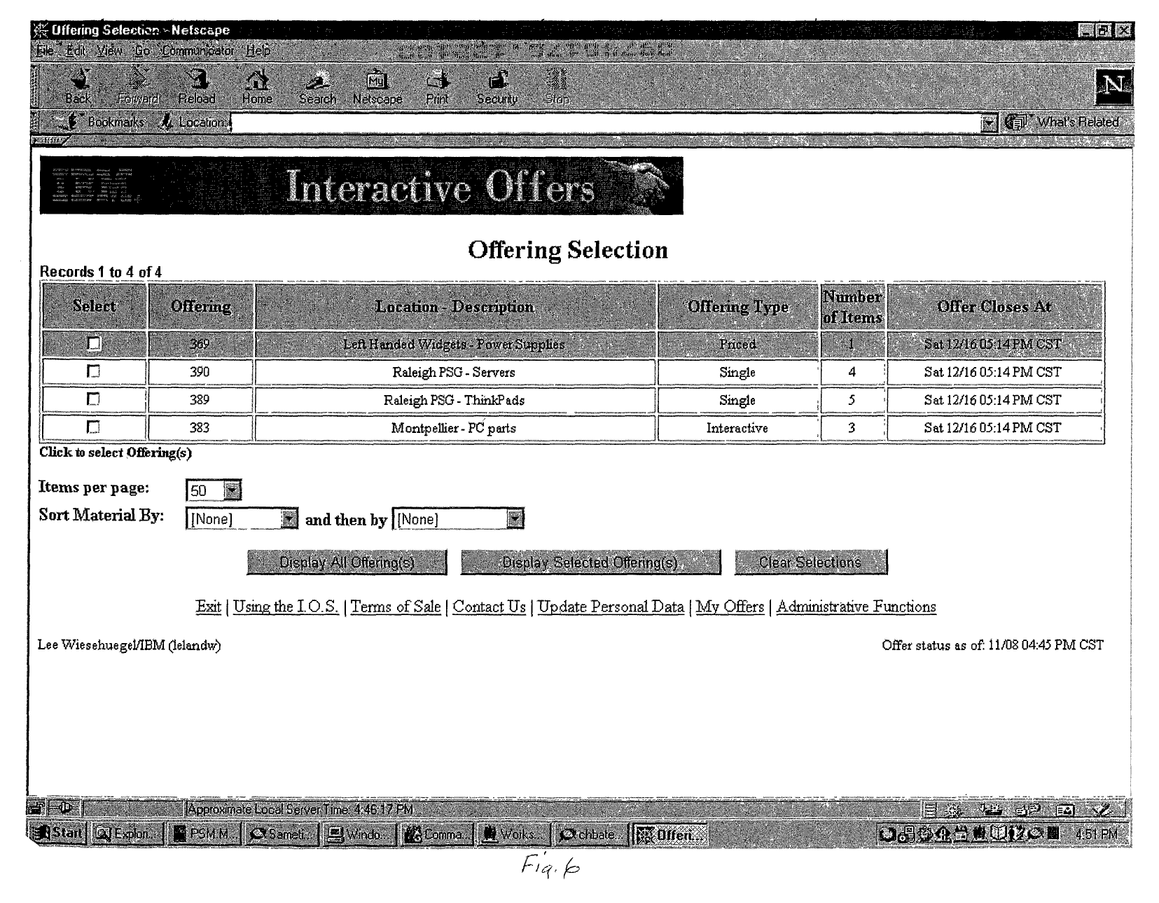

FIG. 5 depicts a block diagram which illustrates a data processing system which may be implemented as one or more broker consoles 58. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 5. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 5 may vary depending on the implementation. Other internal hardware or peripheral devices, such as flash ROM (or equivalent nonvolatile memory) or optical disk drives and the like, may be used in addition to or in place of the hardware depicted in FIG. 5. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 5 and above-described examples are not meant to imply architectural limitations. For example, data processing system 300 also may be a notebook computer or hand held computer in addition to taking the form of a PDA. Data processing system 300 also may be a kiosk or a web appliance.

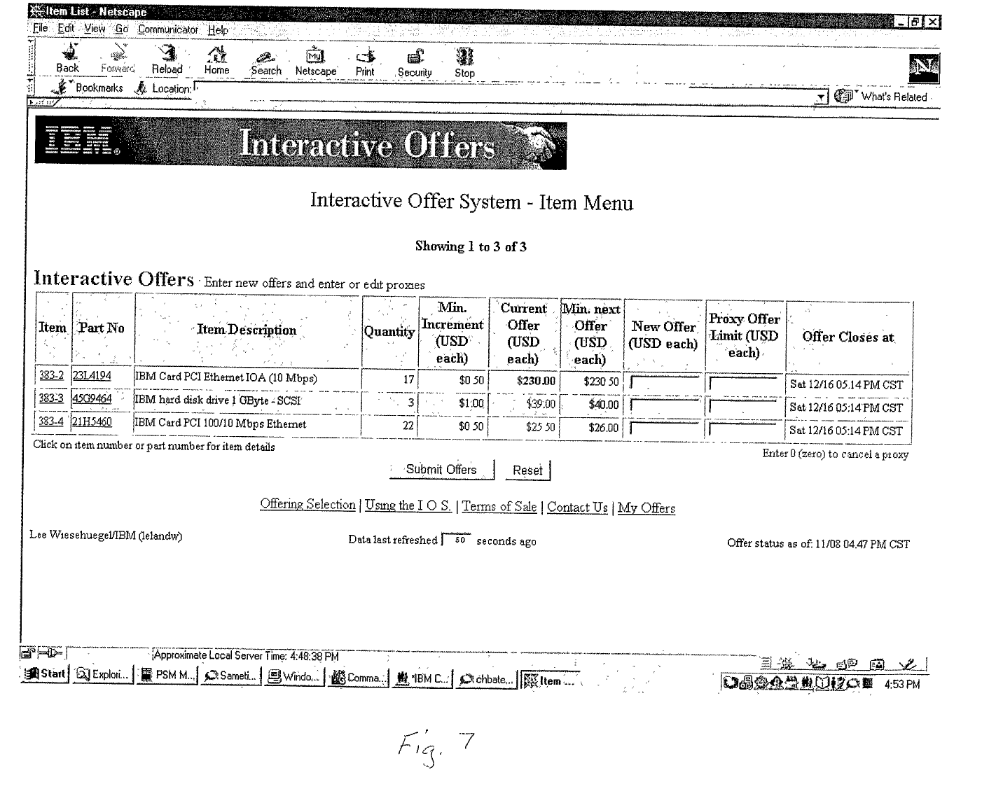

FIG. 6 illustrates a single screen image which depicts simultaneously displaying all offerings currently for auction according to the present invention. As depicted in FIG. 6, four different offerings are currently available for sale to a particular buyer. Each offering has an associated offering type. The offering type describes the type of auction to be conducted to sell that particular offering. In FIG. 6, one offering is a “priced” offering, two are “single” offerings, and one is an “interactive” offering.

In a “priced” offering, an item is made available at a pre-established price. The item is sold on a first-come, first-served basis. A potential buyer may make an offer to buy any available priced item prior to the close of an offer. Items are sold to the first buyer who submits a bid for the pre-established price.

For the purposes of this disclosure, the term “item” will mean something which is offered for sale in an auction on which a potential buyer may bid. An item may include one or more things. For example, the term “item” as used herein may refer to a single part lot which include multiple parts. “Item” has also been used herein to refer to multiple part lots.

In a “single” offering, also called a “sealed” offer, a potential buyer submits a blind bid. At any time before the offer closes, or expires, the potential buyer may modify or cancel the bid. A potential buyer is not permitted to view bids made by other potential buyers.

In an “interactive” offering, a potential buyer may view the current bid made for an item. The potential buyer must then make a bid which exceeds the current bid. Some interactive offerings specify a required increment such that the next bid must exceed the current bid by the specified increment amount.

In interactive offerings, a proxy offer is often permitted. A proxy offer allows a potential buyer to participate in the ongoing auction without having to constantly monitor the auction. A potential buyer may enter a proxy offer which is the maximum price this potential buyer is willing to pay for the item. The proxy offer will automatically enter the minimum increment price necessary to exceed the current bid up to the amount of the proxy offer.

The screen image illustrated by FIG. 6 indicates that the power supply offering includes one lot, the servers offering includes four lots, the ThinkPads offering includes five lots, and the PC parts offering includes three lots. A potential buyer may select one or more of these offerings from the current screen image.

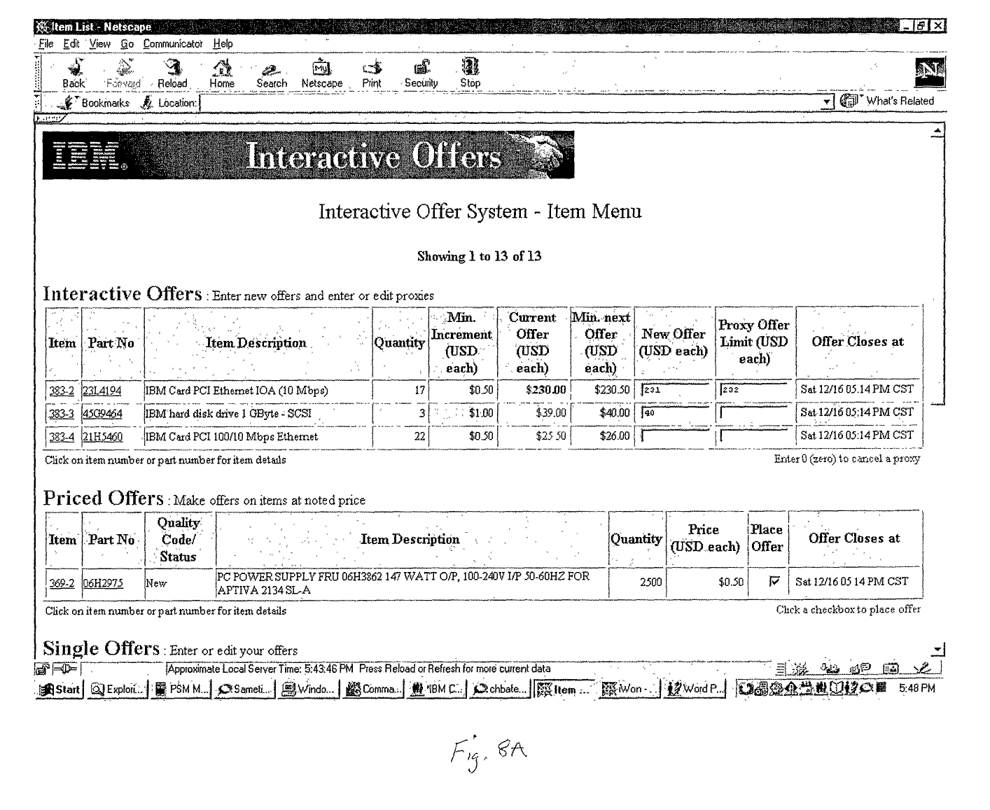

FIG. 7 depicts a single screen image which illustrates simultaneously displaying all part lots of one offering when only one offering is selected from the screen image of FIG. 6 according to the present invention.

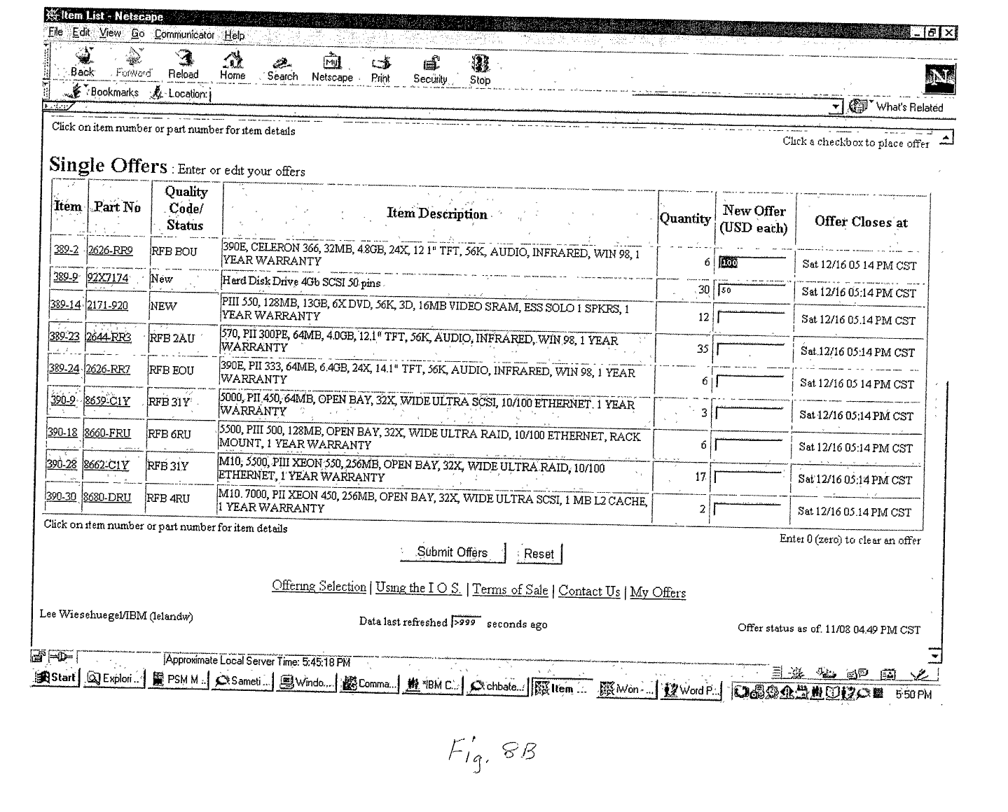

FIGS. 8A and 8B together illustrate a single screen image which depicts simultaneously displaying all part lots of all offerings when all offerings are selected from the screen image of FIG. 6 according to the present invention. The part lots included in each offering are grouped according to each offering's type.

Each single screen image of the present invention is preferably a single web page. Those skilled in the art will recognize that some web pages are too large to be completely displayed on a display screen at one time. Therefore, as is well known in the art, a cursor may be used to scroll through the entire page. The single screen image of the present invention is a single web page even though some pages, such as depicted by FIGS. 8A and 8B, are too large to be completely displayed without the need for scrolling through the page.

For interactive offerings, a new offer entry field and a proxy offer entry field are displayed. A potential buyer may enter an amount into the new offer field for one or more offerings. In addition, a potential buyer may also enter a proxy for one or more offerings.

For priced offerings, a place offer entry field is displayed. If the buyer wishes to buy an item which is offered using a priced offering type, the buyer must simply select the place offer entry field.

For single offerings, a new offer entry field is displayed. A potential buyer may enter a bid amount into the entry field for one or more single offers.

A potential buyer, thus, may enter a bid for multiple different items from the same screen display. In addition, the buyer may enter bids on different items which are offered using different offer types, or auction types. In the example depicted in FIGS. 8A and 8B, a potential buyer has entered a bid for two different items which are offered as interactive offers, one item offered as a priced offer, and two items offered as single offers. All of these different bids have been entered from the same screen image. All of the offers are then submitted simultaneously.

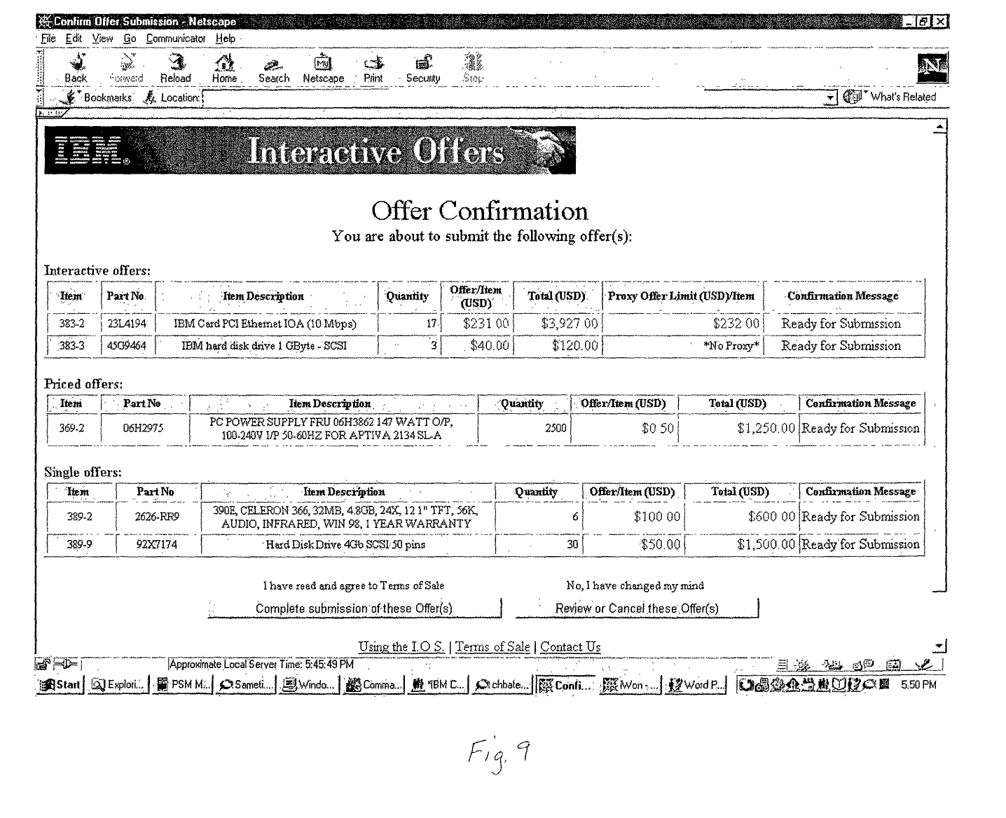

FIG. 9 illustrates a single screen image which depicts simultaneously confirming all offers prior to the offers being recorded according to the present invention. The confirmations for all submitted bids are simultaneously displayed on a single screen image. FIG. 9 depicts a single confirmation screen which confirms the submission of bids on five different offerings. The potential buyer then may either cancel the bids or complete the submission process in order to have the bids recorded.

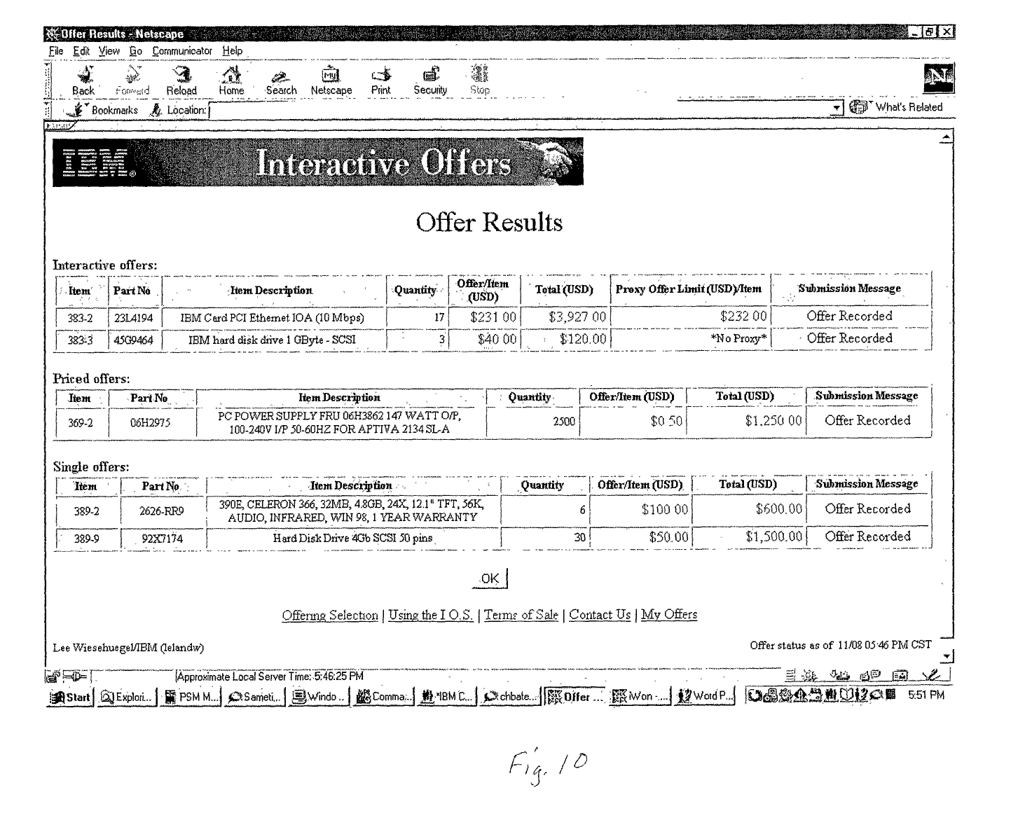

FIG. 10 depicts a single screen image which illustrates a single screen image which indicates the results of the offer submission according to the present invention after the potential buyer confirmed the bids from the screen image depicted by FIG. 9.

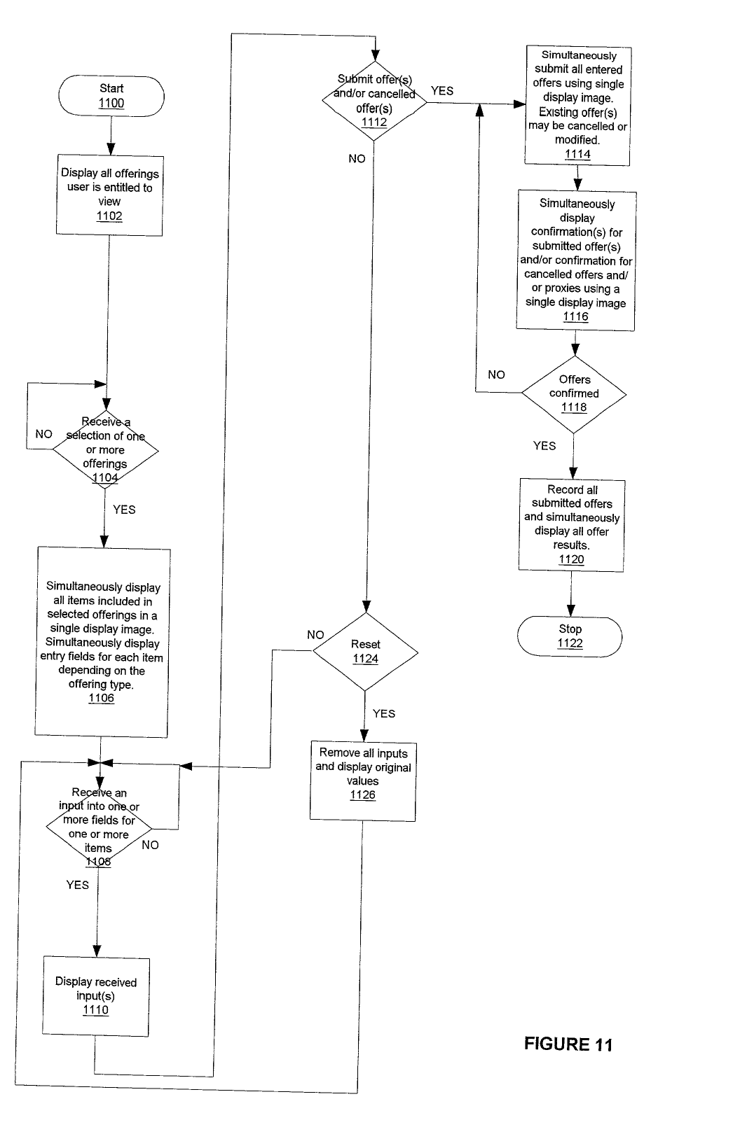

FIG. 11 illustrates a high level flow chart which depicts simultaneously submitting offers on multiple different items in an electronic auction according to the present invention. The process starts as depicted by block 1100 and thereafter passes to block 1102 which illustrates the display of all offerings the potential buyer is entitled to view in a single screen image such as illustrated by FIG. 6. The process then passes to block 1104 which illustrates a determination of whether or not a selection of one or more offerings has been received. If a determination is made that no selection has been received, the process passes back to block 1104. If a determination is made that a selection has been received, the process passes to block 1106 which depicts the simultaneous display of all items included in the selected offerings in a single screen image, such as illustrated by either FIG. 7 or FIGS. 8A and 8B. The single screen image will include entry fields for each item. The entry fields which are displayed for a particular item will depend on the type of offering type of the item. For example, for interactive type offerings, a NEW OFFER field and a PROXY OFFER LIMIT field are displayed. For priced offers, a PLACE OFFER field is displayed. For single offers, a NEW OFFER field is displayed.

The process then passes to block 1108 which illustrates a determination of whether or not an input has been received in one or more entry fields for one or more of the displayed items. If a determination is made that no input has been received, the process passes back to block 1108. If a determination is made that an input has been received in one or more entry fields, the process passes to block 1110 which depicts displaying the received input(s) using the same, single screen image. The process then passes to block 1112 which illustrates a determination of whether or not the offer(s) are to be submitted and/or cancelled. If a determination is made that none of the offer(s) are to be submitted and/or cancelled, the process passes to block 1124 which depicts a determination of whether or not the entry field(s) are to be reset. When the entry field(s) are reset, they are set back to the values which were last submitted for the field(s). If a field was originally empty, the field will be reset to be empty. If, however, the field included a particular value prior to the display of the offerings, as depicted by block 1106, the field will be reset to that particular value. If a determination is made that the entry field(s) are not to be reset, the process passes to block 1108.

Referring again to block 1124, if a determination is made that the one or more entry field(s) are to be reset, the process passes to block 1126 which illustrates removing all new inputs for each entry field and displaying the original values included in the entry fields. The process passes back to block 1008.

Referring again to block 1112, if a determination is made that the offer(s) are to be submitted and/or cancelled, the process passes to block 1114 which depicts simultaneously submitting all entered offers using a single screen image. Next, block 1116 illustrates simultaneously displaying a confirmation for each submitted offer on a single screen image. Thereafter, block 1118 depicts a determination of whether or not the buyer wishes to confirm the offers and any changes made to existing offers. If a determination is made that the buyer does not wish to confirm the offers, the process passes back to block 1114. Referring again to block 1118, if a determination is made that the buyer does wish to confirm the offers and any changes made to existing offers, the process passes to block 1120 which illustrates recording all submitted offers and changes to existing offers. The process then terminates as depicted by block 1122.

It will be understood by those skilled in the art and from the foregoing description that various modifications and changes may be made in the preferred embodiment of the present invention without departing from its spirit and scope. It is intended that this description is for purposes of illustration only and should not be construed in a limiting sense. The scope of this invention should be defined by the following claims.

What is claimed is:

1. A method in an electronic auction for permitting simultaneous submission of bids on multiple different items using a single screen image, said method comprising the steps of:
simultaneously displaying, using a single screen image, a plurality of different items offered for auction;
permitting entry of a different bid for each of a plurality of said plurality of different items using said single screen image; and
simultaneously submitting said bid for each of said plurality of said plurality of different items from said single screen image.

2. The method according to claim 1, further comprising the step of offering each of said plurality of different items for auction using a different one of a plurality of auction types.

3. The method according to claim 2, further comprising the step of offering one of said plurality of different items for auction using an interactive auction.

4. The method according to claim 2, further comprising the step of offering one of said plurality of different items for auction using a single auction.

5. The method according to claim 2, further comprising the step of offering one of said plurality of different items for auction using a priced auction.

6. The method according to claim 2, further comprising the steps of:
offering a first one of said plurality of different items for auction using a priced auction;
offering a second one of said plurality of different items for auction using an interactive auction; and
offering a third one of said plurality of different items for auction using a single auction.

7. The method according to claim 1, further comprising the step of displaying, utilizing said single screen image, an offer of one of said plurality of different items for auction using a single auction.

8. The method according to claim 1, further comprising the steps of:
displaying, utilizing said single screen image, an offer of a first one of said plurality of different items for auction using a single auction;
displaying, utilizing said single screen image, an offer of a second one of said plurality of different items for auction using a priced auction; and
displaying, utilizing said single screen image, an offer of a third one of said plurality of different items for auction using an interactive auction, wherein said first, second, and third ones of said plurality of different items are simultaneously displayed utilizing said single screen image.

9. The method according to claim 1, further comprising the steps of:
receiving said different bid for each of said plurality of said plurality of different items using said single screen image; and
simultaneously displaying a confirmation for said different bid for each of said plurality of said plurality of different items using a second single screen image.

10. The method according to claim 1, further comprising the step of simultaneously submitting a different bid for each one of a first plurality of said plurality of different items and submitting a modification for a each one of a second plurality of said plurality of different items.

11. The method according to claim 10, further comprising the step of simultaneously submitting a different bid for each one of a first plurality of said plurality of different items and cancelling each one of a second plurality of said plurality of different items.

12. The method according to claim 11, further comprising the step of simultaneously submitting a different bid for each one of a first plurality of said plurality of different items and revising each one of a second plurality of said plurality of different items.

13. The method according to claim 3, further comprising the step of permitting an entry of a proxy for at least one of said plurality of said plurality of different items utilizing said single screen image.

14. The method according to claim 13, further comprising the step of simultaneously submitting said bid for each of said plurality of said plurality of different items and said proxy for at least one of said plurality of said plurality of different items utilizing said single screen image.

15. The method according to claim 1, wherein the step of simultaneously displaying, using a single screen image, a plurality of different items offered for auction further comprises the step of simultaneously displaying, using said single screen image, a plurality of different offerings offered for auction, wherein an offering includes one or more items.

16. The method according to claim 1, further comprising the steps of:
selecting a plurality of said plurality of different offerings to display to a particular user; and
simultaneously displaying, using said single screen image, only said plurality of said plurality of different offerings.

17. An electronic auction system for permitting simultaneous submission of bids on multiple different items using a single screen image, comprising:
a single screen image for simultaneously displaying a plurality of different items offered for auction;
means for permitting entry of a different bid for each of a plurality of said plurality of different items using said single screen image; and
said single screen image for simultaneously submitting said bid for each of said plurality of said plurality of different items from said single screen image.

18. The system according to claim 17, further comprising a plurality of auction types wherein each of said plurality of different items is offered for auction using a different one of said plurality of auction types.

19. The system according to claim 18, further comprising said single screen image for offering one of said plurality of different items for auction using an interactive auction.

20. The system according to claim 18, further comprising said single screen image for offering one of said plurality of different items for auction using a single auction.

21. The system according to claim 18, further comprising said single screen image for offering one of said plurality of different items for auction using a priced auction.

22. The system according to claim 21, further comprising:
said single screen image for offering a first one of said plurality of different items for auction using a priced auction;
said single screen image offering a second one of said plurality of different items for auction using an interactive auction; and
said single screen image for offering a third one of said plurality of different items for auction using a single auction.

23. The system according to claim 17, further comprising said single screen image for displaying an offer of one of said plurality of different items for auction using a single auction.

24. The system according to claim 17, further comprising:
said single screen image for displaying an offer of a first one of said plurality of different items for auction using a single auction;
said single screen image for displaying an offer of a second one of said plurality of different items for auction using a priced auction; and
said single screen image for displaying an offer of a third one of said plurality of different items for auction using an interactive auction, wherein said first, second, and third ones of said plurality of different items are simultaneously displayed utilizing said single screen image.

25. The system according to claim 17, further comprising:
said single screen image for receiving said different bid for each of said plurality of said plurality of different items using said single screen image; and
a second single screen image for simultaneously displaying a confirmation for said different bid for each of said plurality of said plurality of different items.

26. The system according to claim 17, further comprising said single screen image for simultaneously submitting a different bid for each one of a first plurality of said plurality of different items and submitting a modification for a each one of a second plurality of said plurality of different items.

27. The system according to claim 26, further comprising said single screen image for simultaneously submitting a different bid for each one of a first plurality of said plurality of different items and for cancelling each one of a second plurality of said plurality of different items.

28. The system according to claim 26, further comprising said single screen for simultaneously submitting a different bid for each one of a first plurality of said plurality of different items and for revising each one of a second plurality of said plurality of different items.

29. The system according to claim 19, further comprising said single screen image permitting an entry of a proxy for at least one of said plurality of said plurality of different items.

30. The system according to claim 29, further comprising said single screen image for simultaneously submitting said bid for each of said plurality of said plurality of different items and said proxy for at least one of said plurality of said plurality of different items.

31. The system according to claim 17, further comprising said single screen image for simultaneously displaying a plurality of different offerings offered for auction, wherein an offering includes one or more items.

32. The method according to claim 17, further comprising:
means for selecting a plurality of said plurality of different offerings to display to a particular user; and
said single screen image for simultaneously displaying only said plurality of said plurality of different offerings.

33. A computer readable medium including an electronic auction for permitting simultaneous submission of bids on multiple different items using a single screen image, said computer readable medium comprising:
instruction means for simultaneously displaying, using a single screen image, a plurality of different items offered for auction;
permitting entry of a different bid for each of a plurality of said plurality of different items using said single screen image; and
simultaneously submitting said bid for each of said plurality of said plurality of different items from said single screen image.

34. The computer readable medium according to claim 33, further comprising instruction means for offering each of said plurality of different items for auction using a different one of a plurality of auction types.

35. The computer readable medium according to claim 34, further comprising instruction means for offering one of said plurality of different items for auction using an interactive auction.

36. The computer readable medium according to claim 34, further comprising instruction means for offering one of said plurality of different items for auction using a single auction.

37. The computer readable medium according to claim 34, further comprising instruction means for offering one of said plurality of different items for auction using a priced auction.

38. The computer readable medium according to claim 34, further comprising:
instruction means for offering a first one of said plurality of different items for auction using a priced auction;
instruction means for offering a second one of said plurality of different items for auction using an interactive auction; and
instruction means for offering a third one of said plurality of different items for auction using a single auction.

39. The computer readable medium according to claim 33, further comprising instruction means for displaying, utilizing said single screen image, an offer of one of said plurality of different items for auction using a single auction.

40. The computer readable medium according to claim 33, further comprising:
instruction means for displaying, utilizing said single screen image, an offer of a first one of said plurality of different items for auction using a single auction;
instruction means for displaying, utilizing said single screen image, an offer of a second one of said plurality of different items for auction using a priced auction; and
instruction means for displaying, utilizing said single screen image, an offer of a third one of said plurality of different items for auction using an interactive auction, wherein said first, second, and third ones of said plurality of different items are simultaneously displayed utilizing said single screen image.

41. The computer readable medium according to claim 33, further comprising:
instruction means for receiving said different bid for each of said plurality of said plurality of different items using said single screen image; and
instruction means for simultaneously displaying a confirmation for said different bid for each of said plurality of said plurality of different items using a second single screen image.

42. The computer readable medium according to claim 33, further comprising instruction means for simultaneously submitting a different bid for each one of a first plurality of said plurality of different items and submitting a modification for a each one of a second plurality of said plurality of different items.

43. The computer readable medium according to claim 42, further comprising instruction means for simultaneously submitting a different bid for each one of a first plurality of said plurality of different items and cancelling each one of a second plurality of said plurality of different items.

44. The computer readable medium according to claim 42, further comprising instruction means for simultaneously submitting a different bid for each one of a first plurality of said plurality of different items and revising each one of a second plurality of said plurality of different items.

45. The computer readable medium according to claim 35, further comprising instruction means for permitting an entry of a proxy for at least one of said plurality of said plurality of different items utilizing said single screen image.

46. The computer readable medium according to claim 43, further comprising instruction means for simultaneously submitting said bid for each of said plurality of said plurality of different items and said proxy for at least one of said plurality of said plurality of different items utilizing said single screen image.

47. The computer readable medium according to claim 34, wherein the instruction means for simultaneously displaying, using a single screen image, a plurality of different items offered for auction further comprises instruction means for simultaneously displaying, using said single screen image, a plurality of different offerings offered for auction, wherein an offering includes one or more items.

48. The computer readable medium according to claim 34, further comprising:
instruction means for selecting a plurality of said plurality of different offerings to display to a particular user; and
instruction means for simultaneously displaying, using said single screen image, only said plurality of said plurality of different offerings.
